(19) United States
(12) Patent Application Publication
(10) Pub. No.: US 2015/0369455 A1
(43) Pub. Date: Dec. 24, 2015

(54) LIGHTING ARRANGEMENT OF OPERATING THEATRE

(71) Applicant: MERIVAARA OY, Lahti (FI)

(72) Inventor: Jyrki Nieminen, Lahti (FI)

(21) Appl. No.: 14/764,793

(22) PCT Filed: Jan. 27, 2014
(86) PCT No.: PCT/FI2014/050064

§ 371 Date: Jul. 30, 2015

(30) Foreign Application Priority Data
Jan. 30, 2013 (FI) 20135089

(51) Int. Cl. F21V 14/02; F21V 21/008; F21V 21/30; F21V 33/00

(52) U.S. Cl. CPC F21V 14/02; F21V 33/0068; F21V 21/008; F21V 21/30; F21W 2131/205

(57) ABSTRACT

A lighting arrangement having a lighthead support, including one mounting plane which consists of a plurality of mounting brackets set in a single plane fitted with light elements and being rod-like members which are aerodynamic at least in a direction transverse, and the light elements containing at least one light emitting diode, whereby said mounting brackets are disposed in the proximity of a ceiling preferably above an operating table so as to be located immediately below a supply air frame of the facility to be illuminated and in such a way that a supply air flowing through the supply air frame is adapted to retain its constant angle of incidence with the mounting plane regardless of where the object of illumination is located in the to-be-illuminated facility with respect to the mounting plane or regardless of the direction of a light beam generated by each light source or LED.

### RELATED APPLICATIONS

This application is a National Phase entry of PCT Application No. PCT/FI2014/050064, filed Jan. 27, 2014, which claims priority from Finland Application No. 20135089, filed Jan. 30, 2013, the disclosures of which are hereby incorporated by referenced herein in their entirety.

### FIELD OF THE INVENTION

The present invention generally relates to a lighting arrangement for an operating theatre or the like facility. More particularly, the present invention is directed to a lighting arrangement for an operating theatre having a lighthead support having a plurality of mounting brackets for light elements set in a substantially single mounting plane, such that a supply air flowing through a supply air frame is adapted to retain its constant angle of incidence with the single mounting plane. The present invention also relates generally to a method for diverting in a supply air frame a light beam generated by the lighting arrangement's light source or LED.

### BACKGROUND OF THE INVENTION

The operating theatre necessitates good lighting, especially those areas of an operating theatre used for surgery. In addition, lighting is particularly focused on the part of a patient's body about to be treated with surgical procedures.

The conventional operating theatre lighting arrangement comprises a general lighting system and one or more surgical lightheads provided in the vicinity of and above the operating table. A prior known surgical lighthead comprises a fixed lighthead frame, which is provided with a plurality of light sources such as halogen lamps or the like, and generally a flexible spring arm for attaching the lighthead to ceiling structures and for adjusting its position relative to the operating table and the surgical patient resting thereon.

Prior known from the published German patent application DE 102006040393 is a surgical lamp, comprising a plurality of light segments assembled on a single frame and constructed from light emitting diodes or LEDs fitted with optics. This surgical lamp is also intended to be attached with a spring arm to the ceiling structures of an operating theatre.

The prior known surgical lightheads are generally very much alike in design. A problem with surgical lightheads is particularly the frame design and the attachment to ceiling structures. The lighthead frame is solid, heavy, and awkward. The adjustment of a lighthead position is conducted manually, whereby there is a risk of the lighthead colliding with other operating theatre equipment during the course of its displacement. Another problem during a procedure relates to the surgeon's possible contacts with non-sterile surfaces. Also, cleaning the lighthead is a laborious task.

Still another problem with prior known surgical lightheads is being most often installed in the operating theatre within a feeding zone of clean supply air. The flow of supply air has a purpose of impeding the access of impurities to the operating table and the surgical site of a patient, but the airflow-blocking pieces of equipment, particularly surgical lightheads, disrupt the laminar airflow coming downward from above and thereby compromise patient safety.

Accordingy, there is a need in the industry of lighting arrangements for theatre lighting in surgical settings that address the problems and laborious tasks associated with the prior art.

### SUMMARY OF THE INVENTION

An object of the present invention is, among other things, to eliminate the problems related to prior known surgical lightheads. It is also an object of the present invention to provide a new improved operating theatre lighting arrangement, which preferably enables the control of even general operating theatre lighting and particularly spotlighting for an operating table and thereby surgical procedures.

The lighting arrangement according to certain aspects of the present invention is implemented by means of light emitting diodes or LEDS and is characterized in that the lighting arrangement comprises a lighthead support, including one mounting plane which consists of a plurality of mounting brackets for light elements which are set in a single plane, said mounting brackets being rod-like members which are aerodynamic at least in a direction transverse, most preferably perpendicular to the mounting plane, and across which the air is able to flow, said mounting brackets being fitted with a plurality of light elements containing at least one light emitting diode, such that said light elements are for the most part thereof located inside the mounting brackets, whereby at least some of said light elements comprise a light source or LED, whereby said mounting brackets are disposed in the proximity of a ceiling of an operating theatre or the like facility, essentially above an operating table so as to be located immediately below a supply air frame of the facility to be illuminated and in such a way that a supply air flowing through the supply air frame is adapted to retain its constant angle of incidence with the mounting plane regardless of where the object of illumination is located in the to-be-illuminated facility with respect to the mounting plane or regardless of the direction of a light beam generated by each light source or LED.

In certain aspects of the present invention, the lighting arrangement is characterized in that the light elements are disposed on the mounting bracket in a row successively at a small distance from each other.

In certain aspects of the present invention, the lighting arrangement is characterized in that the mounting brackets are straight and/or curved, narrow, chute-like, rigid, and dimensionally stable elements.

In certain aspects of the present invention, the lighting arrangement is characterized in that the mounting brackets have a cross-section which is a circle or ellipse, or at least a top portion of the mounting bracket is wedge-shaped and/or rounded and a width of the mounting bracket is preferably less than its height.

In certain aspects of the present invention, the lighting arrangement is characterized in that the width of each mounting bracket in a plane perpendicular to its longitudinal direction is not more than in the order of 2-3 times a maximum diameter of the light element in its transverse plane, i.e. the one co-directional with the mounting plane.

In certain aspects of the present invention, the lighting arrangement is characterized in that the lighthead support comprises a frame, the mounting brackets being fixed thereto and the mounting plane extending via said frame.

In certain aspects of the present invention, the lighting arrangement is characterized in that the mounting brackets are disposed in the proximity of the ceiling of an operating theatre or the like facility essentially above the operating table, and most preferably so as to be located below the supply air frame of the facility to be illuminated.

In certain aspects of the present invention, the lighting arrangement is characterized in that the lighting arrangement comprises deflection and displacement elements, by means of which, if necessary, the lighthead support is capable of being deflected to an angle relative to the supply airflow arriving at the supply air frame, as well as capable of being lifted and/or lowered.

In certain aspects of the present invention, the lighting arrangement is characterized in that the mounting brackets are disposed side by side at a certain distance from each other.

In certain aspects of the present invention, the lighting arrangement is characterized in that a first plurality of the mounting brackets are disposed by side by side, at a distance from each other, and a second plurality of the mounting brackets are disposed at an angle, preferably at a right angle, with respect to the first mounting brackets.

In certain aspects of the present invention, the lighting arrangement is characterized in that the lighting arrangement further comprises a control unit, by which is adjusted at least one of the following features of the light elements: switching the light element on/off and its magnitude of fight intensity, setting a focus of the light beam, a direction of the light beam, and deflecting the lighthead support relative to the supply airflow.

In certain aspects of the present invention, the lighting arrangement is characterized in that the lighting arrangement control unit controls the light elements to produce lighting on an object of illumination on the basis of a difference between locations of a portable pointer device and the light elements, as well as on a position of the pointer device.

In certain aspects of the present invention, the lighting arrangement is characterized in that the portable pointer device has at least one acceleration sensor for determining its position.

In certain aspects of the present invention, the lighting arrangement is characterized in that, as lighting is produced on an object of illumination, taken into account is also a distance between the portable pointer device arid the object to be illuminated.

In certain aspects of the present invention, the lighting arrangement is characterized in that the lighting arrangement also comprises a control system, which includes a detection unit for detecting a location of the pointer device with respect to the light elements and/or a light unit.

In certain aspects of the present invention, the lighting arrangement is characterized in that the portable pointer device or the lighthead unit has detection elements for determining the light elements to be used for lighting.

On the other hand, the method according to the invention for diverting an LED-generated light beam in a supply air frame is characterized in setting a lighthead support and a mounting plane at a specific angle, preferably at an angle of about 90 degrees, with respect to a supply airflow for generating a specific low constant air resistance between the supply airflow and the lighthead support's mounting brackets, and directing, as the location of an object of illumination changes, a light beam generated by the light source or LED from the previous object of illumination to a new object of illumination without moving the mounting planes, such that the angle of incidence between the mounting plane and the supply airflow remains unchanged.

In certain aspects of the present invention, the method is characterized in that the laminar supply airflow proceeds through the lighthead support in the form of a substantially laminar flow.

The present invention relates to a lighting arrangement implemented by means of light emitting diodes or LEDs. The lighting arrangement comprises a lighthead support, including a plurality of mounting brackets for light elements which are set in a substantially single mounting plane and which are rod-like members aerodynamic at least in a direction (B-B) transverse, most preferably perpendicular to the mounting plane, and across which the air is able to flow, said mounting brackets being fitted with a plurality of light elements containing at least one light emitting diode, whereby at least some of said light elements comprise a light source or LED, whereby said mounting brackets are disposed in the proximity of the ceiling of an operating theatre or the like facility, essentially above the operating table, in order to be located immediately below a supply air frame (TF) of the facility to be illuminated, and in such a way that the supply air flowing through the supply air frame (TF) is adapted to remain at a constant angle of incidence with the mounting plane regardless of where the object of illumination is located in the illuminated facility with respect to the mounting plane or regardless of the direction of a light beam generated by each light source or LED.

On the other hand, the method according to the invention for diverting a lighting arrangement in a supply air frame (TF) comprises the following steps of:
setting the lighthead support and the mounting plane at a specific angle, preferably at an angle of about 90 degrees, with respect to a supply airflow (C) for generating a specific low constant air resistance between the supply airflow and the lighthead support's mounting brackets,
directing, as the location of an object of illumination changes, the light source or LED-generated light beam from the previous object of illumination to a new object of illumination without moving the mounting planes, such that an angle of incidence (d1, d2) between the mounting plane and the supply airflow remains unchanged.

In a preferred embodiment of the invention, the light elements are located inside the mounting brackets.

The mounting plane refers in this application to a virtual plane co-directional with the mounting brackets, extending across the mounting brackets at a specific height thereof, such as along a longitudinal center line of the mounting brackets. The vertical direction of a mounting bracket is understood to be a direction transverse to the mounting plane of said bracket.

The plane of a lighthead support extends along the mounting plane and comprises mounting brackets, as well as generally also a support structure, such as a frame, to which said mounting brackets are attached.

In a preferred embodiment of the present invention, the mounting brackets are straight and/or curved, narrow, chute-like, rigid, and dimensionally stable elements. These are preferably arranged to extend side by side and spaced from each other particularly across the area which demands high-intensity light. The mounting brackets are optionally set up in such a way that some of the brackets are at an angle, such as at a right angle, against other brackets.

In another preferred embodiment of the present invention, at least some of the mounting brackets are narrow, chute-like, rigid, and dimensionally stable elements taking the shape of a circle or other shape of plane geometry, which are most preferably fitted in a single plane inside one another or to cross over or intersect each other. The mounting brackets are optionally arranged in such a way that a first number of brackets are elements in the shape of a circle or other shape of plane geometry, and a second number of brackets are curved and/or straight, narrow, chute-like, rigid, and dimensionally stable elements at an angle, preferably at a right angle, against the first elements.

In a preferred embodiment of the present invention, the light elements are fitted on a mounting bracket successively in a row at a small distance from each other. In one preferred embodiment of the invention, the width of a mounting bracket in a plane perpendicular to its longitudinal direction, i.e. in a mounting plane, is not more than in the order of 2-3 times the maximum diameter of a light element in its lateral plane. In addition, the light elements are disposed on the same side of the mounting plane and in such a way that the light produced by the light elements is directed away from the mounting plane.

In another preferred embodiment of the present invention, the lighting arrangement comprises swiveling and displacing elements, which enable whenever necessary the lighthead support to be swiveled to an angle relative to the supply airflow arriving in a supply air frame, as well as to be lifted and/or lowered.

In still another preferred embodiment of the present invention, the lighting arrangement's lighthead support is swiveled in a supply air frame in such a way that the lighthead support and the mounting plane assume a specific angle, preferably an angle of about 90 degrees, relative to a supply airflow in order to establish a specific low constant air resistance between the supply airflow and the lighthead support's mounting brackets, and, in addition, the light beam generated by a light source or LED is adapted to be diverted away from the mounting plane level.

A benefit of such an invention is that the light field produced by the lighting arrangement can be arbitrarily refashioned and at the same time the sterile laminar supply airflow, which is fed inside from the operating theatre's ceiling structures and directed towards the floor, can be retained in a laminar condition by setting the lighthead support at such an angle relative to the supply airflow arriving in a supply air frame that the mounting brackets have a low resistance to flow. The mounting brackets included in the lighting arrangement are additionally designed to be aerodynamic in the above-mentioned direction of flow, thus neither blocking the passage of air nor essentially changing the propagation direction of air as it flows through the lighthead support.

The present invention is based on adapting the supply airflow to arrive in a supply air frame of the lighting arrangement, and further at a lighthead support therebelow, at a specific constant angle of incidence at which the lighting arrangement's mounting brackets present a low air resistance. Since the light elements are located inside the mounting brackets, and the light beam generated thereby can be diverted as desired, this enables the light beams generated by the light elements to be diverted towards a number of desired targets while retaining the mounting brackets' resistance to flow in the supply airflow at this same, low level.

Therefore, the sterile airflow, coming towards the operating table from above, is without interference focused on the surgical site and contributes effectively to blocking the access of bacteria to the surgical wound. Hence, in this respect as well, the risk of postoperative infection is lower than before.

The focusing of light on the operating table area, and especially on the surgical site of a patient, is implementable with a lighting arrangement of the invention. The focused light field is modifiable in terms of its extent and shape as per surgical requirements and situation. The general lighting of an operating theatre is also implementable with a lighting arrangement of the invention.

A benefit of the present invention is that the risk of physical contact with the lighting arrangement's light sources or its parts in general is practically eliminated and the possible access of bacteria to the surgical wound by way of contact with the lighting arrangement in the proximity of an operating table within the sterile area is prevented. The lighting arrangement is generally in a sufficiently high position with respect to the floor level to put it beyond the reach of a surgeon or assistant working at the operating table. Thus, the risk of postoperative infection is lower than before. It should also be noted that the assisting staff need not step into the sterile area for the adjustment of a surgical lighthead, because the surgical lighthead is integrated with the lighting arrangement disposed in the proximity of the operating theatre ceiling. Another benefit of the invention is that the movable and/or swivelable implements and/or accessories do not collide with the lighting arrangement's light sources or its parts in general.

A benefit gained by a lighting arrangement of the present invention is a simple attachment of the lighthead support to ceiling structures. The lighthead support is suspended from various sides thereof with appropriate suspension elements, such as a plurality of supporting ropes or the like, to the ceiling structures, especially outside the area defined by a supply air frame of the operating theatre. Hence, there is no need for any ceiling mount in the central ceiling area and inside the supply air frame. The lighthead support suspension arrangement also improves and simplifies the ceiling structure.

Another benefit of the present invention is that the lighting arrangement can be supplemented in a simple manner with appropriate accessories, such as a camera assembly, light focusing equipment, e.g. a laser pointer.

In a preferred embodiment of the present invention, the light elements are maneuvered by a lighting arrangement control unit to produce lighting for a target to be illuminated on the basis of a difference between locations of a pointer device and the light elements, as well as on the position of a pointer device.

It is preferred that the portable pointer device be provided with at least one acceleration sensor for determining its position.

Preferably, when lighting is produced for a target to be illuminated, the distance between the portable pointer device and the target to be illuminated is also taken into consideration.

An advantage gained by such a lighting arrangement of the present invention is that the object of lighting is easy to point out with a portable device, and thereafter the system control unit is capable of focusing the lighting on the pointed site without having to touch the lighthead manually.

A benefit provided by a lighting arrangement of the present invention is versatility and programmability, which enables various lighting functions to be conducted with one and the same physical assembly.

A benefit provided by a lighting arrangement of the present invention is a simple design and friendliness in manufacturing. Another benefit of the invention is good usability, reliability, and safety.

Still another benefit provided by a lighting arrangement of the present invention is being almost maintenance-free since Led light elements, for example, have a long service life.

### BRIEF DESCRIPTION OF THE DRAWINGS

The present invention and its other benefits will now be described in more detail with reference to the accompanying drawing, in which

FIG. 1 shows from lateral direction, in a partial section view, an operating theatre which is outfitted with a lighting arrangement according to certain aspects of the present invention;

FIG. 2 shows in a view from below the lighting arrangement shown in FIG. 1;

FIG. 3 shows descriptively, in a partial cross-section view, a light element disposed on a mounting bracket;

FIG. 4 shows schematically a lighting arrangement control unit and its connection with the lighting arrangement's light elements and with a remote controller;

FIG. 5A shows schematically, from the viewing angle of FIG. 1, a supply airflow arriving upon a lighthead support of the lighting arrangement shown in FIG. 1; and

FIGS. 5B-5C show schematically an angle of incidence formed by a mounting plane of the lighthead support of FIG. 5A with the supply airflow.

FIGS. 6A-6B show functional units for as well as the appearance of a portable pointer device.

FIGS. 6C-6D show how the lighting arrangement is maneuvered with a control system, comprising a portable pointer device.

### DETAILED DESCRIPTION OF THE DRAWINGS

In the figures, like components are designated with like reference numerals.

The present invention relates generally to a lighting arrangement, which is implemented by means of light diodes, i.e. LEDs (light emitting diode).

The lighting arrangement according to the present invention is particularly intended for an operating theatre or the like facility, but it is adaptable for use also in other types of rooms or facilities, such as workrooms, in which effective, preferably focusable lighting is required i.e. for carrying out precise and demanding work.

The lighting arrangement comprises a lighthead support 1, which is constructed from a plurality of mounting brackets 2; 2¹, 2², 2³, . . . , 2ⁿ (n=positive integer) for light elements. The mounting bracket 2 is fitted with a plurality of light elements 3, which contain at least one light emitting diode 31 functioning as a light source. The mounting brackets 2 are organized in an essentially single plane, i.e. in a mounting plane 10 (section A-A). The mounting plane 10 is a plane which extends across all mounting brackets 2; 2¹, 2² . . . 2⁸ at an equal height of the mounting brackets, i.e. it is the specific plane which contains the lengthwise section planes of the mounting brackets 2. The height of a mounting bracket refers here to the mounting bracket's dimension in a perpendicular direction B-B relative to the mounting plane 10.

Thus, the lighthead support 1 lies basically in a single plane in which gaps 4 between the mounting brackets 2 are open. The lighthead support 1 also comprises the mounting plane 10 co-directional with the lighthead support. The mounting brackets 2 are aerodynamic rod-like elements at least with respect to the direction B-B transverse, preferably perpendicular relative to the mounting plane 10 established by the mounting brackets. In addition, the gap 4 between two adjacent mounting brackets is set to be sufficiently large with respect to the entire surface area of the mounting plane 10. Thereby, air is easily able to flow through between the mounting brackets 2.

Thus, air is allowed to flow through the entire lighthead support 1. Hence, the mounting brackets 2 have a low air resistance in the crosswise direction B-B of the mounting base 10.

The angle of incidence of the mounting brackets 2 relative to a supply airflow C is maintained constant, i.e. at the same time, that of the lighthead support 1 and the mounting plane 10 relative to the supply airflow is kept unchanged. If the location of an object of illumination changes with respect to the lighthead support 1, and at the same time with respect to the mounting plane 10, the direction of a light beam generated by the light source or LED is changed with directing elements, such as a deflection motor 33, while the direction of the lighthead support 11 is kept unchanged. The angle of incidence of mounting brackets relative to the supply airflow C is not changed unless there is a change in the direction of the supply airflow.

The mounting brackets 2 have a cross-section in the shape of a circle or an ellipse, or at least a top portion 21 of the mounting bracket 2 is wedge-shaped and/or rounded. Thus, a width l of the mounting bracket 2 is preferably less than its height “k”.

The mounting bracket 2 may have a length varying e.g. between 150-300 cm, but other lengths are also possible depending on the intended use. The mounting bracket 2 has its width “l” for example in the order of 20-40 mm, but other lateral dimensions are also possible.

The mounting brackets 2 are most preferably made of metal, such as aluminum, or other suchlike relatively light, rigid, and dimensionally stable material, such as appropriately reinforced plastics. The mounting brackets 2 are rod-like elements, preferably provided with a trough or a plurality of successive recesses, which is/are capable of having the light elements installed therein.

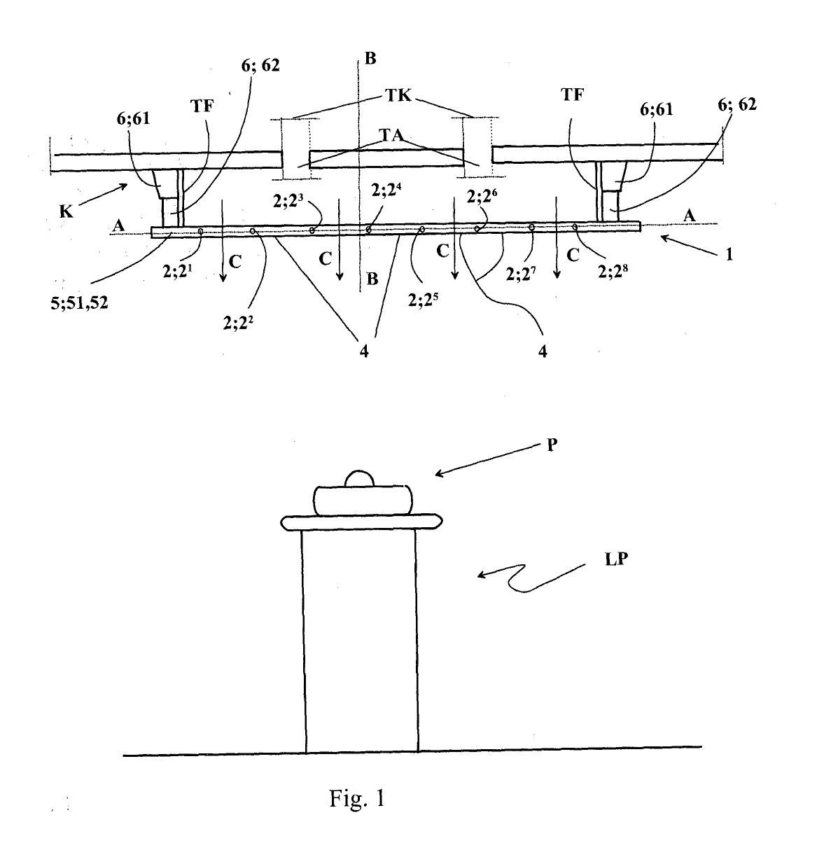

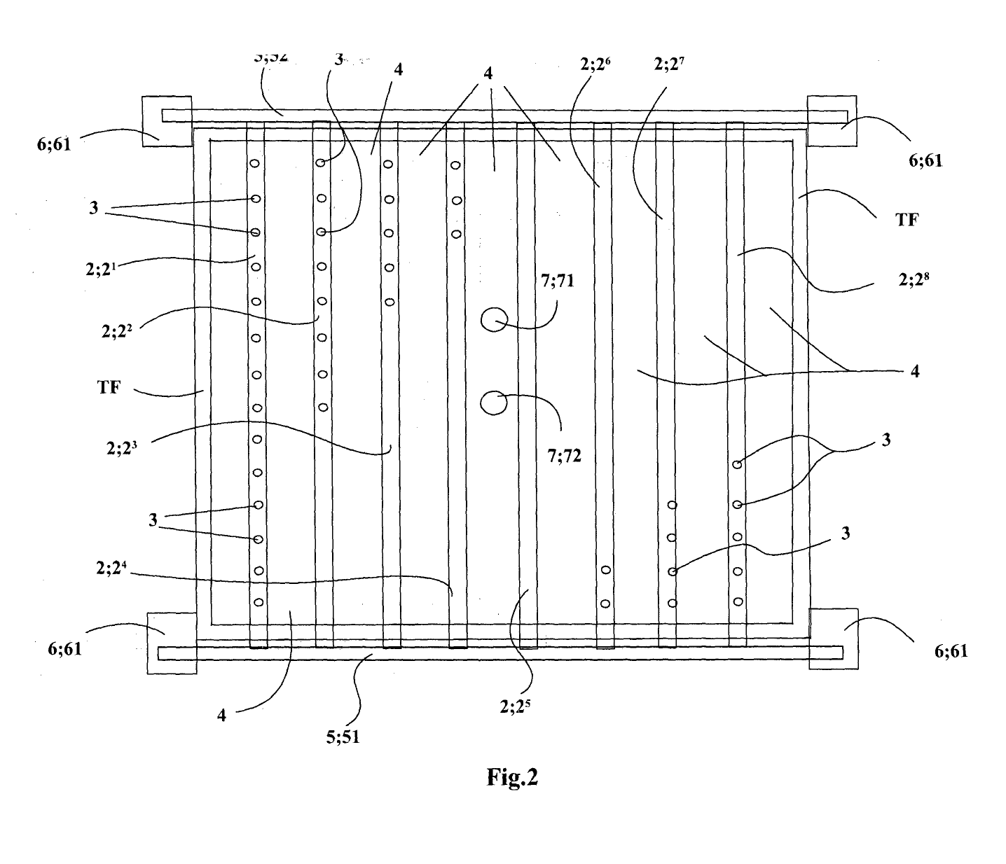

In a preferred embodiment of the invention, the mounting bracket 2 are straight elements arranged side by side at a distance from each other. In the exemplary embodiment of FIGS. 1 and 2, the lighthead support 1 is in a rectangular shape. Alternatively, the mounting brackets are elements having the shape of a circle or other plane geometric shape, which are fitted in a single plane inside each other at a distance from each other. In this case, the lighthead support is respectively in the shape of a circle or in other plane geometric shape. It should be noted, however, that, in some embodiments of the invention, the mounting brackets 2 also contain elements present at an angle relative to each other, such as those that are perpendicular to and intersecting (or passing through) each other.

In a preferred embodiment of the invention, the light elements 3 are fitted primarily inside the mounting bracket 2, in a row lengthwise of the mounting bracket, successively at a small distance from each other. The light elements are preferably disposed in such a way inside the mounting bracket that the optics thereof extends to below a bottom edge of the mounting bracket. However, the light elements 3 are left in their entirety within the mounting bracket and a protective cover 35 associated with the mounting bracket's bottom edge.

The light elements 3 are placed on the side of the mounting plane and in such a way that the light generated by the light elements 3 is directed away from the mounting plane, i.e. from that side of the mounting plane on which the light elements are located. In one preferred embodiment of the invention, the width “l” of the mounting bracket 2 in a plane perpendicular to its longitudinal direction, and at the same time in the mounting plane 10, is not more than in the order of 2-3 times a maximum diameter a of the light element 3 in its transverse plane.

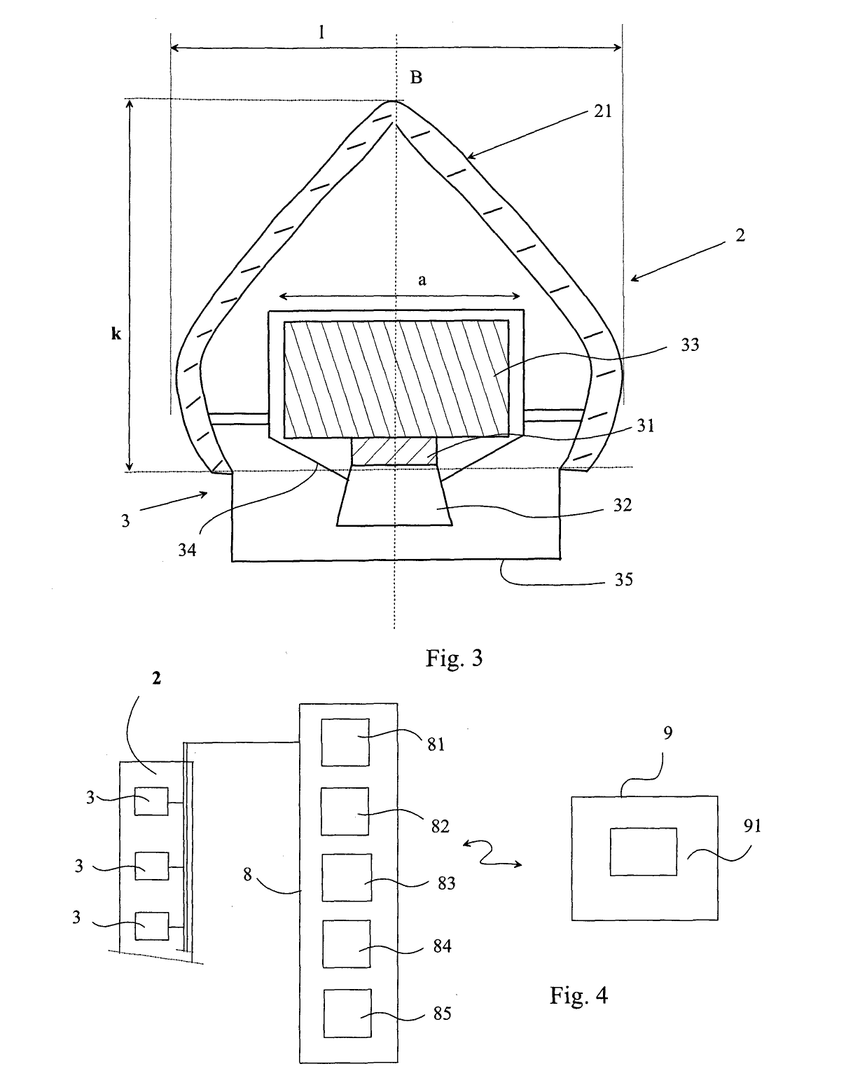

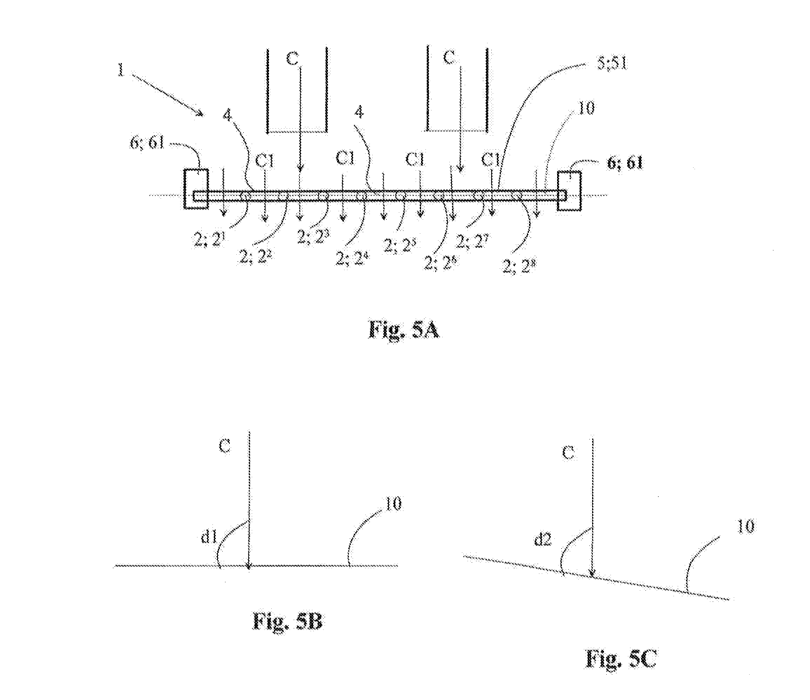

In a preferred embodiment of the invention, at least some of the light elements 3 comprise not only the light source or LED 31 but also adjustable optics or a lens assembly 32 and direction control devices 33, such as an electrically driven turning motor, which are fitted to each other and most preferably in a common continuous enclosure 34. The enclosure 34 is present inside the mounting bracket 2. The light element 3 comprises preferably also a transparent protective cover 35, which is provided for protecting the optics 32 and through which propagates the LED-generated light. Preferably, protection for the optics 32 of the light elements 3 disposed inside a mounting bracket is provided by the common continuous protective cover 35 in engagement with a bottom edge 22 of the mounting bracket 2. As seen from FIG. 3, the light element has its optics 32 extending slightly beyond the mounting bracket's bottom edge 22, being left inside the common protective cover 35 associated with the bottom edge 22 of the mounting bracket 2.

In addition, the lighthead support 1 comprises most preferably a frame 5 or other suchlike bracing structure with the mounting brackets 2; 2¹, 2², 2³, . . . fastened thereto. The frame 5 lies essentially in one and the plane with the mounting plane 10 of the mounting brackets 2 and makes up a structure in a geometric shape, such as a square, rectangle, circle, ellipse, or other equivalent shape, which defines the lighthead support on at least two opposite sides. In the embodiment of FIGS. 1 and 2, the frame 5 consists of two end supports 51, 52, which are disposed in a longitudinal direction of the mounting brackets 2 at the opposite ends thereof.

The frame 5, such as the end supports 51, 52, is constructed most preferably from long rod-like elements, which in one embodiment of the invention are substantially similar to the mounting brackets 2. It should be noted, however, that other types of long rod-like members can also be used in the frame.

The lighthead support 1 is suspended from various sides thereof with appropriate suspension elements, such as with a plurality of supporting ropes 71 or the like, to ceiling structures, particularly outside the area defined by a supply air frame TF of the operating theatre.

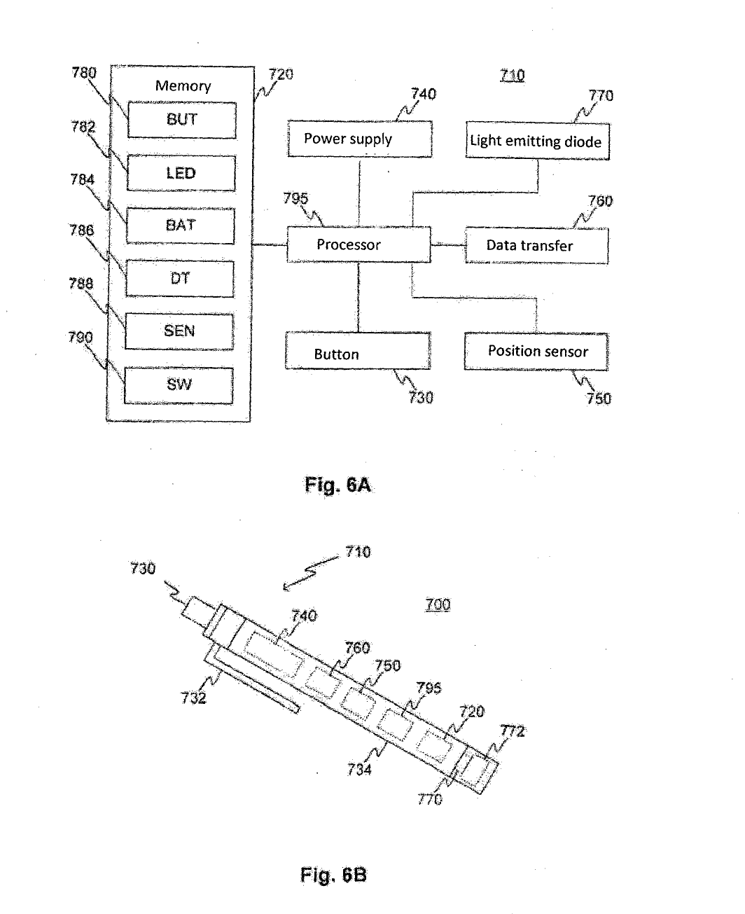

The lighting arrangement in preferred embodiment of the present invention comprises also displacement elements 6, which enable the lighthead support 1 to be lifted and/or lowered as necessary. The displacement elements 6 comprise a power unit, such as one or more electric motors 61, and suspension elements, such as a plurality of the supporting ropes 71 or the like, between the frame 5 and the swivel axis of a power unit, such as the electric motor 61. In the embodiment depicted in the drawing, there are four pieces of suspension elements, such as the supporting ropes 71, and electric motors 61 on various sides of the frame 5 in the proximity of the corners of the rectangle-shaped lighthead support 1 at ceiling structures. The displacement elements 6 enable the lighthead support 1, that is the frame 5 and the mounting brackets 2, to be maneuvered in vertical direction. Hence, the lighthead support 1 can be lowered from ceiling structures downward to a desired height and, respectively, lifted back upward to the proximity of ceiling structures. The lighthead support 1, and at the same time the mounting plane as well, can also be set by means of the displacement element 6 to a desired angle with respect to a horizontal plane, as illustrated in FIGS. 5A-5C. Thereby, the mounting plane 10 and the supply airflow C can always be maintained in such an orientation that the mounting brackets 2 are always positioned aerodynamically with respect to the supply airflow C.

The lighting arrangement in a preferred embodiment of the present invention comprises preferably at least one accessory 7, such as a digital camera 71 and/or a light pointer 72. The camera 71 is mounted on the lighthead support 1, such as on a suitable mounting bracket 2, and is directed to photograph downward at least a part of the illuminated area. Alternatively (or along with the camera as a supplemental accessory), the light pointer 72, such as a laser or LED pointer, is respectively mounted on the lighthead support 1, such as on a suitable mounting bracket 2, and is directed to point downward to the illuminated area. The light pointer is provided with a directing device for enabling the light pointer's narrow light beam to indicate a site that light must be focused on for attaining a desired overall density of light, such as e.g. the surgical site of a patient.

The lighting arrangement according to the present invention is particularly suitable for an operating theatre or the like facility, such as a clean room. The lighthead support 1, along with its mounting brackets 2; 2¹, 2², 2³, . . . , 2⁸ (and possible frame 5), is disposed in the proximity of an operating theatre ceiling K above an operating table LP as illustrated in FIG. 1. Especially in an operating theatre, the lighthead support 1 is set within an area defined by the supply air frame TF and directly below this area, such that the supply air (arrows C in FIG. 1) flows towards upper parts 21 of the mounting brackets 2 and flows downwards through gaps between the mounting brackets 2. Consequently, the supply air C comes across the lighthead support's plane or the mounting plane 10 at a certain angle, which is generally a right angle.

Hence, the lighthead support 1 lies below one or more supply air openings TA of a supply air channel TK, the supply air C being able to discharge as a substantially laminar flow C1 from the supply air openings present inside the supply air frame through the lighthead support 1, that is through gaps 4 between the lighting support's 1 mounting brackets 2; 2¹, 2², 2³, . . . , downward towards the operating table LP and a surgical patient P thereon, and to diffuse away from the operating table to discharge air channels or the like air outlet channels.

In a preferred embodiment of the present invention, the lighting arrangement further comprises a control unit 8, FIG. 5, for adjusting at least the light elements 3 mounted on the lighthead brackets 2 of the lighthead support 1. The control unit 8 comprises preferably at least three adjustment units 81, 82, 83.

The first adjustment unit 81 is intended for regulating power supply and/or for adjusting light intensity for the light source 31 of each light element 3. The first adjustment unit 81 is connected to the light source 31 of each light element 3, especially to a power supply V thereof, for allowing and disconnecting the power feed via the first adjustment unit 81 to this particular light source, and for regulating its power, and thereby its light intensity, within a predetermined range. In case the light element 3 contains several LEDs, the light produced thereby having spectral ranges differing from each other, it is also possible to adjust the color temperature of light produced by the light element 3.

The second adjustment unit 82 is intended for adjusting the optics 32 of each light element 3 and for focusing the light beam of the light source 31 at a desired distance. This enables the light beam of each light element 3 to be focused e.g. at a determined level, as regarded, among other things, from the plane of an operating table. The second adjustment unit 82 is connected to an adjustment means for the optics 32 of each light element 3.

The third adjustment unit 83 is intended for controlling direction control devices 33, such as an electric motor, for the light source 31 of each light element 3, and a lever assembly or the like associated with the light element. This way, the light beam of the light source of each light element 3 is capable of being directed onto a predetermined area of the operating table, and particularly onto a surgical patient. Thus, the orientation of a light beam generated by the light element's light source 32 is capable of being changed while the angle of incidence for the mounting plane and the supply airflow C, and at the same time the resistance to flow between the supply airflow C and the lighthead support 1, will be maintained constant.

FIGS. 5A-5C depict in detail the way of setting the lighthead support and at the same time also the mounting plane 10 at a certain angle of incidence d1 or d2 with respect to the supply airflow C.

FIGS. 5A and 5B show how the lighthead support 1 and at the same time also the mounting plane 10 have been set horizontally below two supply air openings TA of a supply air channel. Visible in FIG. 5A is one end support 5, 51 of the lighthead support's frame with respective ends of the rod-like mounting brackets 2; 2¹ . . . 2; 2⁸ connected thereto. The laminar supply air C arrives from the supply air openings present inside the supply air frame and comes to contact with the horizontal lighthead support 1 at an angle d1. The angle of incidence d1 is roughly 90 degrees, i.e. a right angle. Between the lighthead support's 1 mounting brackets 2; 2¹ . . . 2; 2⁸ and the supply airflow C develops a certain low constant resistance to flow, by virtue of which the laminar supply airflow C is able to discharge in a still substantially laminar flow C1 through the lighthead support 1, that is through gaps between the mounting brackets 2; 2¹, 2², 2³, . . . , down towards the operating table.

In FIG. 5C, the lighthead support 1 and at the same time the mounting plane 10 have been deflected by means of displacement elements 6; 61 relative to horizontal plane, such that an angle of incidence d2 between the mounting plane 10 and the supply airflow C deviates slightly from a right angle. The resistance to flow between the lighthead support's 1 mounting brackets 2; 2¹ . . . 2; 2⁸ and the supply airflow C is slightly different from that between a horizontally set mounting plane and a supply airflow arriving at a 90 degree angle relative thereto (FIG. 5B). However, the resistance to flow continues to be sufficiently low for the laminar supply airflow C to discharge in a substantially laminar flow C1 through the lighthead support 1.

The control unit 8 comprises preferably also a fourth adjustment unit 84, which is intended for controlling the displacement elements 6, 7 such as one or more electric motors 61, 62, 63, 64. The control unit 8, particularly the fourth adjustment unit 84, enables each electric motor to be controlled in such a way that a desired height for the lighthead support 1, as determined e.g. from the floor level, will be attained.

The control unit 8 further comprises most preferably a plurality of sensors, which are connected to the various adjustment units 81, 82, 83, 84 for obtaining measurement information from the lighting arrangement in order to conduct and monitor the adjustment functions.

The accessory 7, such as the digital camera 71 and/or the light pointer 72, is combined with the control unit 8. Information obtained from the accessory 7; 71, 72 is utilized in the control unit 8 and, respectively, the control unit is used for operating and adjusting the accessories.

The control unit 8 further comprises one or more monitoring units 85, by means of which e.g. the lighting arrangement is monitored for safety and possible malfunctions are reported.

The control unit, especially its adjustment units 81, 82, 83, 84, 85, is used for monitoring and regulating the light element 3 regarding at least one of its following features: switching the light element on/off and magnitude of its light intensity (and color temperature), setting a focus for the light beam and a direction for the light beam. Hence, at least a portion of the light generated by the light elements 3 can be focused on a patient on the operating table and, in addition, across a desired (focal) area.

The control unit 8, along with its adjustment units 81, 82, 83, 84, 85, is most preferably implemented by means of a microprocessor or the like data processing unit included in a control system 700. In this case, the functions of the adjustment units 81, 82, 83, 84 and 85 are effected by means of computer programs and, hence, the lighting arrangement operates in a program-controlled manner.

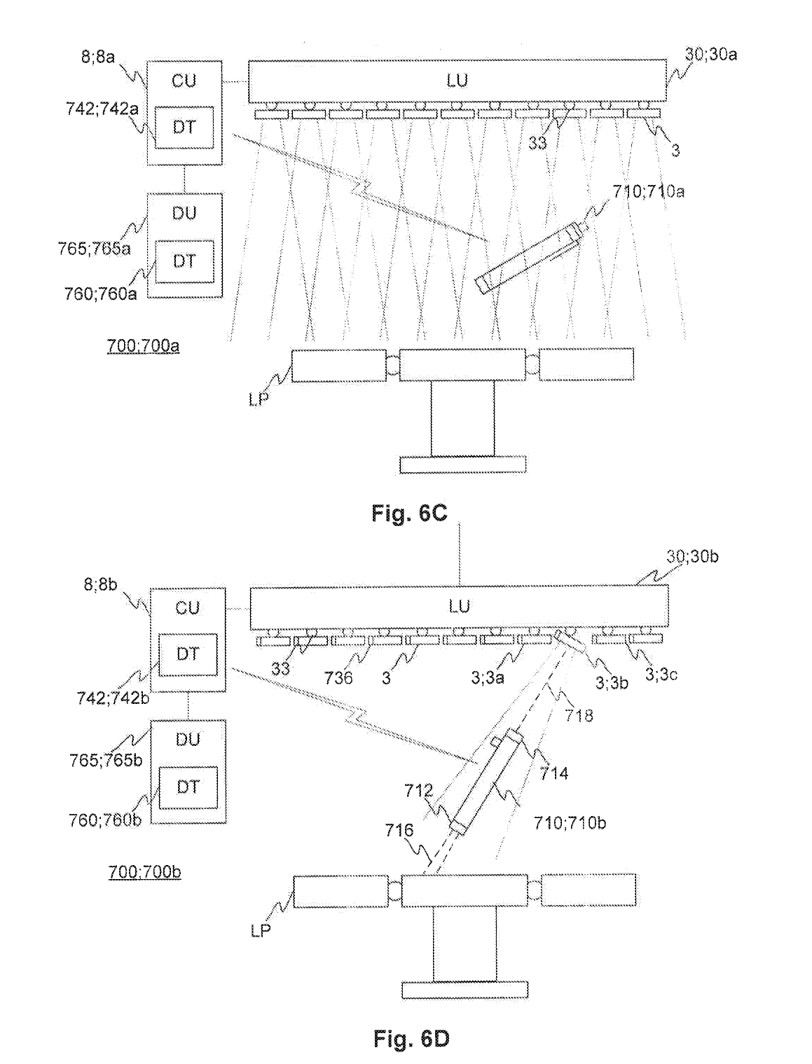

Operation of the control system 700 according to a preferred embodiment of the invention is depicted in even more detail in FIGS. 6A-6D, wherein the control system 700 comprises the control unit 8 as well as a portable pointer device 710, such as a light pen, used for controlling operation of the lighting arrangement's light elements 3.

FIG. 6A shows a lighting arrangement control system, wherein the lighting control is carried out not with the light pointer 72 but with a portable pointer device 710, in which is encapsulated at least one processor 795 used for executing instructions determined for example by a user or an application program and for processing data. The pointer device 710 has at least one memory 720 for example for recording and storing instructions, as well as at least one physical function key 730, for example an on/off button, as well as possibly one or more control buttons for receiving the user's control commands. The at least one function key 730 may comprise separate function keys for at least one of the following functions: intensity adjustment for lighting, control of a laser rangefinder (not shown), determination of the size/shape of an area to be illuminated, and adjustment of color temperature. The pointer device 710 can also be implemented in such a way that, instead of or in addition to color temperature, it is possible to regulate at least one other optical property of lighting, such as for example intensifying and/or weakening the light of some specific spectral range with respect to other light, for example accentuating the red or some other color as necessary.

The pointer device 710 is additionally provided with at least one battery 740 functioning as a power supply, which is positioned in the pointer device 710 so as to enable its replacement or recharging through the intermediary of a separate recharging device or a recharging interface (not shown) included in the pointer device, at least one position sensor 750 for determining the orientation, a data transfer unit 760 comprising at least an RF and/or IR transmitter for communicating position data along with other data to the lighting control unit in a wireless manner. Alternatively, the data transfer unit 750 may comprise an RF and/or IR transceiver, whereby software sets of the pointer device 710 can be updated over a wireless communication from the control unit or some other computer. In addition, the pointer device 710 includes a light emitting diode unit 770, comprising at least one light emitting diode, for facilitating the focusing of the pointer device by means of a light beam generated thereby. The pointer device 710 may include also another light emitting diode unit 770, comprising at least one light emitting diode, or a laser/IR transmitter which is positioned at one end of the elongated pointer device 710 and which is used for determining one or more light elements to be used for lighting the target.

The memory 720 comprises at least one program 780 controlling operation of the function key, at least one program 782 controlling operation of the light emitting diode, at least one program 784 controlling operation of the battery, a program 786 controlling operation of the data transfer unit 760, at least one program 788 controlling operation of the position sensor 750, and a program 790 by means of which the pointer device 710 is in turn used for controlling the lighting arrangement's light elements 3.

In a portable pointer device 710 according to one embodiment of the present invention, in its memory 720 is stored a computer program 790, which is adapted, jointly with the processor 795, to determine a position of the pointer device 710 intended for the focusing of lighting provided by the lighting arrangement with at least one position sensor 750 for producing position data, and to transmit, by means of the data transfer unit 760, the position data to the control unit 8, which is intended for controlling the light elements 3 and which controls each light element 3 in such a way that said light element 3 produces a light beam to an object to be illuminated from a direction determined by the position data and location data of the pointer device, said location data having been produced by determining the location of the portable pointer device with respect to each light element.

In a pointer device 710 according to one embodiment of the present invention, which has been set forth in any of the preceding embodiments, the position of the pointer device 710 is determined with the at least one acceleration sensor 750 and with the at least one processor 795. A pointer device 710 according to one embodiment, which has been set forth in any of the preceding embodiments and which is further adapted to determine, by means of the at least one processor 710, the intensity of lighting for producing intensity data on the basis of a command received via a control button 730 intended for its adjustment,

A pointer device 710 according to one embodiment of the present invention, which has been set forth in any of the preceding embodiments and which is further adapted to determine, by means of the at least one processor 795 and a laser rangefinder, its distance to an object to be illuminated in order to generate distance-related data.

A pointer device 710 according to one embodiment of the present invention, which has been set forth in any of the preceding embodiments and which is further adapted to determine, by means of the at least one processor 795, the size and/or shape of an area to be illuminated in order to generate area-related data on the basis of a command received via the control button 730 intended for the adjustment thereof and on the basis of the position data of the pointer device 710.

A pointer device 710 according to one embodiment of the present invention, which has been set forth in any of the preceding embodiments and which is further adapted to determine, by means of the at least one processor 795, the color temperature of lighting on the basis of a command received via the control button 730 intended for its adjustment in order to generate color temperature data.

A pointer device 710 according to one embodiment of the present invention, which has been set forth in any of the preceding embodiments and which is further adapted, by means of the data transfer unit 760, in a wireless manner, along with the position data to transmit to the control unit at least one of the following: intensity data, area-related data, and temperature color data, and the control unit controls the lighthead unit on the basis of data received thereby.

In a computer program 790 according to one embodiment of the present invention, which enables lighting to be controlled with the portable pointer device 710 and which is executed with the processor 795, there is a determination code for determining a position the pointer device 710 intended for the focusing of lighting and for producing position data, and a transmission code for sending the position data to the control unit 8, which is intended for controlling the lighting arrangement and which controls the lighting arrangement's light elements in such a way that the lighting arrangement control system 700 produces illumination on an object from a direction determined by the position data and location data, said location data having been generated by determining the location of the pointer device 710 with respect to the light elements/light element.

In a computer program 790 according to one embodiment of the present invention, which has been set forth in any of the preceding embodiments, which further includes a determination code for determining the intensity of lighting and for generating intensity data.

In a computer program 790 according to one embodiment of the present invention, which has been set forth in any of the preceding embodiments, which further includes a determination code for determining the distance to an object to be illuminated and for generating distance-related data.

In a computer program 790 according to one embodiment of the present invention, which has been set forth in any of the preceding embodiments, which further includes a determination code for determining the size and/or shape of an area to be illuminated and for generating area-related data.

In a computer program 790 according to one embodiment of the present invention, which has been set forth in any of the preceding embodiments, which further includes a determination code for determining the color temperature of lighting and for generating color temperature data.

The computer program 790 can also be implemented in such a way that, instead of or in addition to color temperature, it is possible to regulate, by means of the determination code, at least one other optical property of lighting, such as for example the intensification and/or weakening the light of some specific spectral range with respect to other light, for example accentuating the red or some other color as necessary.

In a computer program 790 according to one embodiment of the present invention, which has been set forth in any of the preceding embodiments, which further includes a transmission code for sending the position data in a wireless manner to the control unit along with at least one of the following: intensity data, area-related data, and color temperature data, said control unit controlling the lighthead unit on the basis of information received thereby.

In a computer program 790 according to one embodiment of the present invention, which has been set forth in any of the preceding embodiments, the discussed computer program is a computer program product, comprising a computer readable data transfer medium provided with a computer program code intended to be executed with a computer.

FIG. 6B shows one embodiment for the pointer device 710, i.e. a so-called light pen. Inside a cylindrical body 734 of the pointer device is packed a processor 795, a memory unit 720, a function key 730, whereby a lighting command is issued by pressing and the intensity of lighting is determined by the duration of pressing, a replaceable battery 740, a position sensor unit 750, and a data transfer unit 760 fitted with an RF transmitter. The light beam intended for pointing is produced with light emitting diodes 770 and optics 772 thereof. Whenever not in use, the pointer device 710 can be fixed by the user to the edge of a pocket or the lapel of a jacket with a clip 732, under which is provided a threaded attachment (not shown) of the pointer device 710 by which it can be opened for replacing the old battery 740 with a new one. The pointer device 710 can also come without the clip 732 for further facilitating sterilization of the pointer device 710.

The pointer device 710 may also include a second light emitting diode, laser, or IR unit, by which the function key 730 is replaced at one end of the pointer device 710. In this case, the function key 730 is fabricated for example on a side of the pointer device 710. This second unit can possibly be used for determining the light elements 3 used for the illumination of an object.

FIG. 6C shows one control system 700; 700a for operating theatre lighting, wherein a portable pointer device 710; 710a is used for pointing a lighting system's lighthead unit 30; 30a, which is mounted on the ceiling of an operating theatre and included in the lighting arrangement, and which comprises a plurality of light elements 3, each of the latter in turn consisting of at least one light emitting diode and optics. In addition, the lighthead unit 30; 30a comprises just partially visible directing elements 33, which are maneuvered with the system's control unit 8; 8a and by means of which it is possible to move the light elements 3 as a single entity, some of the light elements 3 as a group, or each light element 3 individually. With the pointer device 710; 710a it is also possible to control the light elements 3 for example in such a way that the object can be illuminated with two or more separate light beams, each of said light beams being generated by at least one light element 3. It is also possible that the properties of lighting produced by each light beam be adjusted to be different and each light beam be pointed one at a time. The patient (not shown) about to undergo an operation is settled on an operating table LP, around and in the immediate vicinity of which the lighting produced by the lighthead unit 30; 30a is possible to focus in a desired manner In FIG. 6C, the light elements 3 are set up for providing basic illumination directly downward without focusing.

The pointer device 710; 710a includes at least one processor and at least one memory, comprising a computer program, and the at least one memory and the computer program, jointly with the at least one processor, enable the pointer device 710; 710a at least to determine its orientation for producing position data and to transmit wirelessly over an RF and/or IR communication the position data to the control unit 8; 8a, which maneuvers the lighthead unit 30; 30a in such a way that the latter produces illumination on the object from a direction determined by the position data and location data of the pointer device 710; 710a.

The lighting control unit 8; 8a, including at least one processor, at least one memory, and at least one data transfer unit which comprises at least an RF and/or IR receiver, possible also transmitter, by means of which it receives from the pointer device 710; 710a the position data and possibly other information intended for controlling the lighting, for example lighting intensity information, distance information for the pointer device and the object, information regarding the shape and/or size of an object to be illuminated, and color temperature information for lighting and/or information representing at least one other optical property of lighting, such as for example intensifying and/or weakening the light of some specific spectral range with respect to the rest of the light. The data transfer unit 760; 760a enables commands to be transmitted and information regarding the pointer device location to be received in a wireless manner for example by way of an RF and/or IR communication or, as shown in the figure, by way of a cable communication, from a detection unit 765; 765a. The control unit 8; 8a has stored in its at least one memory a computer program, which is adapted, on the basis of received information, to determine a lighting direction determined with the pointer device 710; 710a as well as other lighting-related parameters, and to control, on the basis thereof, the operation of the lighthead unit's 30; 30a light elements 3 and the directing elements 33 thereof, such that the focusing of lighting produced by the light elements 3 and desired by the user can be successfully effected as per commands issued by the user with the pointer device 710; 710a. If necessary, the control unit 8; 8a is capable of individually controlling each light element 3 included in the lighthead unit 30; 30a fitted with the mounting brackets 2.

The control system 700; 700a further includes a detection unit 765; 765a, for example an IR camera or the like, whose function is to monitor a location of the pointer device 710; 710a with respect to the light unit 30; 30a and to use its observations to produce location data for use in the focusing of lighting. The detection unit 765; 765a includes at least one processor, at least one memory, and at least one data transfer unit 760; 760a which comprises at least an RF and/or IR transmitter, possibly also receiver, by means of which it transmits the location data detected thereby regarding the pointer device 710; 710a either automatically or at the request of the control center 8; 8a. The detection unit 765; 765a has stored in its at least one memory a computer program, which is adapted to produce location data regarding the pointer device 710; 710a and to transmit it to the control unit 8; 8a.

In a control system 700 according to one embodiment of the present invention, which has been set forth in any of the preceding embodiments, the position of the pointer device 710 is determined with at least one acceleration sensor.

In a control system 700 according to one embodiment of the present invention, which has been set forth in any of the preceding embodiments, wherein the pointer device 710 is further adapted to determine the intensity of lighting on the basis of a command received via a control button intended for its adjustment for generating intensity data.

In a control system 700 according to one embodiment of the present invention, which has been set forth in any of the preceding embodiments, wherein the pointer device 710 is further adapted to determine its distance to an object to be illuminated for generating distance-related data.

In a control system 700 according to one embodiment of the present invention, which has been set forth in any of the preceding embodiments, wherein the pointer device 710 is further adapted to determine the size and/or shape of an area to be illuminated on the basis of a command received via a control button intended for their adjust, and on the basis of the pointer device position data, for generating area-related data.

In a control system 700 as set forth in any of the preceding embodiments of the present invention, the pointer device 710 is further adapted to determine the color temperature of lighting on the basis of a command received via a control button intended for its adjustment for generating color temperature data. The pointer device 710 can also be of such a design that, instead of or in addition to color temperature, it is possible to adjust at least one other optical property of lighting, such as for example to intensify and/or weaken the light of some specific spectral range with respect to the rest of the light.

In a control system 700 according to one embodiment of the present invention, which has been set forth in any of the preceding embodiments, wherein the pointer device 710 is further adapted to transmit in a wireless manner, along with the position data, to the control unit 8 at least one of the following: intensity data, area-related data, and color temperature data and/or some other data representing an optical property of lighting, and the control unit controls the lighthead unit 30 on the basis of information received thereby, including the location data received thereby from the detection unit 765.

FIG. 6D shows a control system 700; 700b similar to the previous figure, wherein the user operates a pointer device 710; 710b, which includes a light emitting diode unit 712 for pointing out the object and a light emitting diode, laser, or IR unit 714 mounted on the other end, for determining an object, for example a patient, on an operating table LP in order to determine which light elements 3 of a lighthead unit 30; 30b shall participate in lighting. In the example of FIG. 6C, on the other hand, it is the control center 8; 8a which, on the basis pre-agreed instructions and user-issued commands, determines the light elements used for lighting and the focusing thereof.

The lighthead unit 30; 30b comprises a plurality of light elements 3, which are disposed on previously described mounting brackets 2 and each of which has at least one light emitting diode and necessary optics as well as detection elements 736, for example light sensors, adapted to detect a pointing beam coming from the unit 714 and being co-directional with a body of the pointer device 710; 710b. The detection elements 736 can also be implemented in some other way, for example by mounting the same directly on a frame of the lighthead unit 30; 30b. The lighthead unit 30; 30b further includes just partially visible directing elements 33, which are maneuvered by the control unit 8; 8b and by means of which it is possible to move the light elements 3 the same way as described in connection with the preceding FIG. 6C.

The pointer device 710; 710b of FIG. 6D only differs from the pointer device 710; 710a of FIG. 6C in having a function key provided on a side of the body of the pointer device's 710; 710b and in including a unit 714 for determining the light elements 3 of the lighthead unit 30; 30b which participate in the illumination of an object.

The lighting control unit 8; 8b and its data transfer unit 760; 760b are similar to those shown in the previous figure with the difference of being capable, jointly with the detection elements 736, of determining the light elements 3 used for lighting. The detection unit 765; 765b and its data transfer unit 760; 760b are also operatively similar to the respective detection unit 765; 765a and the data transfer unit 760; 760a shown in FIG. 6C.

When pointing to an object (not shown) to be illuminated on the operating table LP with a light beam 716 commencing from a light emitting diode unit 712, the user activates, for example from a function key present on a side of the pointer device 710; 710b or from some other button, the unit 714 which generates a light beam 718 that is parallel to the object-pointing light beam 716 and the body of the pointer device 710; 710b. The detection elements 736 identify the light element 3 towards or to the nearest proximity of which the light beam 718 falls in the lighthead unit 30; 30b and communicate that information to the control unit 8; 8b. On the basis of the light element pointing data, the position data received thereby according to the previous example and possibly other data intended for controlling the lighting, as well as location data, the control unit 8; 8b determines how many light elements 3 is used for lighting the object and how it is conducted. In the case of FIG. 6, the lighting is conducted with the light element 3 on which a light beam 418 falls, whereby the control unit 8; 8b pivots, by means of the actuation mechanisms 33, the light element 3 in such a way that the lighting proceeds co-directionally with the body of the pointer device 710; 710b. If necessary, the lighting can be enhanced by using for example adjacent light elements.

Correspondingly, the user is able to define with the pointer device 710; 710b the boundaries of an area to be illuminated, whereby the detection elements 736 identify the light elements 3 on which the pointer beam 418 falls as the area boundaries are being defined. In the event that, in the process of defining an area, the pointer beam 418 falls on light elements 3a, 3c, the lighting can be conducted solely with those or optionally with all light elements 3a, 3b, 3c indicated by the pointer beam 718 and appearing within the area defined thereby.

In a preferred embodiment of the present invention, the lighting arrangement comprises a remote controller 9, which is used for adjusting the lighting arrangement through the intermediary of a control unit (8). This is most preferably in wireless (a radio or infrared connection) communication with the control unit 8, particularly with its various adjustment units 81, 82, 83, 84, 85. Hence, the remote controller is used for controlling and regulating the lighting arrangement and its various functions. The remote controller 9 is most preferably provided with a touchscreen 91. Discrete symbols for functions of the lighting arrangement and for adjustable properties of the light elements 2 can be provided on the touchscreen.

Described above are just a few exemplary embodiments of the present invention. The principle according to the present invention is naturally subject to modifications within the scope of protection defined by the claims, regarding for example implementation details as well as fields of use.

The present invention is not limited solely to the foregoing exemplary embodiment, but many variations are possible while remaining within an inventive concept defined by the claims.

1. A lighting arrangement, which is implemented by means of light emitting diodes or LEDs, characterized in that the lighting arrangement comprises a lighthead support (1), including one mounting plane (10) which consists of a plurality of mounting brackets (2; 2¹, 2², 2³, . . . ) for light elements which are set in a single plane, said mounting brackets being rod-like members which are aerodynamic at least in a direction (B—embodiment B) transverse, most preferably perpendicular to the mounting plane (10), and across which the air is able to flow, said mounting brackets being fitted with a plurality of light elements (3) containing at least one light emitting diode (31), such that said light elements (3) are for the most part thereof located inside the mounting brackets (2), whereby at least some of said light elements (3) comprise a light source or LED (31), whereby said mounting brackets (2; 2¹, 2², 2³, . . . ) are disposed in the proximity of a ceiling (K) of an operating theatre or the like facility, essentially above an operating table (LP) so as to be located immediately below a supply air frame (TF) of the facility to be illuminated and in such a way that a supply air (C) flowing through the supply air frame (TF) is adapted to retain its constant angle of incidence (d1, d2) with the mounting plane (10) regardless of where the object of illumination is located in the to-be-illuminated facility with respect to the mounting plane (10) or regardless of the direction of a light beam generated by each light source or LED.

2. A lighting arrangement as set forth in claim 1, characterized in that the light elements (3) are disposed on the mounting bracket (2; 2¹, 2², 2³, . . . ) in a row successively at a small distance from each other.

3. A lighting arrangement as set forth in either of the preceding claims, characterized in that the mounting brackets (2) are straight and/or curved, narrow, chute-like, rigid, and dimensionally stable elements.

4. A lighting arrangement as set forth in any of the preceding claims, characterized in that the mounting brackets (2) have a cross-section which is a circle or ellipse, or at least a top portion 21 of the mounting bracket 2 is wedge-shaped and/or rounded and a width (l) of the mounting bracket (2) is preferably less than its height (k).

5. A lighting arrangement as set forth in any of the preceding claims, characterized in that the width (l) of each mounting bracket (2; 2¹, 2², 2³, . . . ) in a plane perpendicular to its longitudinal direction is not more than in the order to 2-3 times a maximum diameter (a) of the light element (2) in its transverse plane, i.e. the one co-directional with the mounting plane (2).

6. A lighting arrangement as set forth in any of the preceding claims, characterized in that the lighthead support (1) comprises a frame (5; 51, 52), the mounting brackets (2; 2¹, 2², 2³, . . . ) being fixed thereto and the mounting plane (10) extending via said frame (5; 51, 52).

7. A lighting arrangement as set forth in any of the preceding claims, characterized in that the mounting brackets (2; 2¹, 2², 2³, . . . ) are disposed in the proximity of the ceiling (K) of an operating theatre or the like facility essentially above the operating table (LP), and most preferably so as to be located below the supply air frame (TF) of the facility to be illuminated.

8. A lighting arrangement as set forth in claim 7, characterized in that the lighting arrangement comprises deflection and displacement elements (6; 61, 62), by means of which, if necessary, the lighthead support (1) is capable of being deflected to an angle (d1, d2) relative to the supply airflow (C) arriving at the supply air frame (TF), as well as capable of being lifted and/or lowered.

9. A lighting arrangement as set forth in any of the preceding claims, characterized in that the mounting brackets (2; 2¹, 2², 2³, . . . ) are disposed side by side at a certain distance (4) from each other.

10. A lighting arrangement as set forth in any claims 1-9, characterized in that a first plurality of the mounting brackets are disposed by side by side, at a distance from each other, and a second plurality of the mounting brackets are disposed at an angle, preferably at a right angle, with respect to the first mounting brackets.

11. A lighting arrangement as set forth in any of the preceding claims, characterized in that the lighting arrangement further comprises a control unit (8), by which is adjusted at least one of the following features of the light elements (3): switching the light element on/off and its magnitude of light intensity, setting a focus of the light beam, a direction of the light beam, and deflecting the lighthead support (1) relative to the supply airflow (C).

12. A lighting arrangement as set forth in claim 11, characterized in that the lighting arrangement control unit (8) controls the light elements (3) to produce lighting on an object of illumination on the basis of a difference between locations of a portable pointer device (710) and the light elements, as well as on a position of the pointer device (710).

13. A lighting arrangement as set forth in claim 12, characterized in that the portable pointer device (710) has at least one acceleration sensor for determining its position.

14. A lighting arrangement as set forth in claim 12 or 13, characterized in that, as lighting is produced on an object of illumination, taken into account is also a distance between the portable pointer device (710) and the object to be illuminated.

15. A lighting arrangement as set forth in claim 14, characterized in that the lighting arrangement also comprises a control system, which includes a detection unit (765) for detecting a location of the pointer device (710) with respect to the light elements (3) and/or a light unit (30).

16. A lighting arrangement as set forth in claim 15, characterized in that the portable pointer device (710) or the lighthead unit (30) has detection elements (736) for determining the light elements (3) to be used for lighting.

17. A method for diverting in a supply air frame (TF) a light beam generated by a light source (31) or LED of a lighting arrangement as set forth in any of claims 1-16, characterized in
setting a lighthead support (1) and a mounting plane (10) at a specific angle (d1, d2), preferably at an angle of about 90 degrees, with respect to a supply airflow (C) for generating a specific low constant air resistance between the supply airflow (C) and the lighthead support's (1) mounting brackets,
directing, as the location of an object of illumination changes, a light beam generated by the light source (31) or LED from the previous object of illumination to a new object of illumination without moving the mounting planes, such that the angle of incidence (d1, d2) between the mounting plane (10) and the supply airflow remains unchanged.

18. A method as set forth in claim 17, characterized in that the laminar supply airflow (C) proceeds through the lighthead support (1) in the form of a substantially laminar flow (C1).
